(19) United States
(12) Patent Application Publication
(10) Pub. No.: US 2008/0225835 A1
(43) Pub. Date: Sep. 18, 2008

(54) COMMUNICATION SERVER

(75) Inventors: Ryuji Oda, Fukuoka-shi (JP); Junji Tagane, Fukuoka-shi (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/029,841

(22) Filed: Feb. 12, 2008

(30) Foreign Application Priority Data
Mar. 16, 2007 (JP) 2007-068692

(51) Int. Cl. H04L 12/66

(52) U.S. Cl. 370/352

(57) ABSTRACT

The SIP server includes a SIP communication controller for controlling transmission/reception of a SIP message complying with SIP, a SIP call controller for controlling calls by using SIP, a call data manager for managing communication state information which indicates communication state with the opposing server and bypass requirement information which indicates the need of skipping the opposing server determined for each session communication on the basis of recovery state of the opposing server, a bypass controller for determining whether to skip the opposing server which is set to be the next destination for each session communication in relaying the SIP message on the basis of the communication state information and the bypass requirement information of the opposing server, and a SIP header controller for editing a Route header of the SIP message in accordance with the result of the determination by the bypass controller.

### BACKGROUND OF THE INVENTION

1. Field of the Invention

The present invention relates to a communication server that uses SIP (Session Initiation Protocol) as a protocol for initiating, changing, and terminating a multi-media session over an IP (Internet Protocol) network including a plurality of servers, and more specifically, to a SIP server that is capable of continuing a session communication between an initiating terminal and a receiving terminal when a trouble occurs with a server relaying the communication in the middle of the session communication and the server is recovered in the middle of the session communication (before the session communication terminates) while involving clearance of a session resource.

2. Description of the Related Art

Conventionally, in an IP network in which a plurality of SIP servers are mutually connected, when a SIP server transmits an INVITE message of SIP to an opposing SIP server and receives no response signal, the SIP server detects that the opposing SIP server has a trouble in its call control function (for example, see Japanese Unexamined Patent Publication No. 2004-179764).

However, because the conventional SIP server detects the trouble on the basis of the response to the INVITE message, the conventional SIP server does not detect a trouble occurred with an opposing SIP server when the session communication has already initiated.

When a trouble has already occurred with another SIP server (referred to as “opposing server” hereinafter) connected to the conventional SIP server itself and the opposing server is not recovered yet before initiating the session communication, no problem arises with the conventional technology because the opposing server is not set in the transmission path (information indicating a sequence of devices through which a message is relayed) of this session communication.

When a trouble has already occurred with the opposing server and the opposing server is recovered before initiating a session communication, the session communication is carried out without problem unless a trouble occurs with the opposing server in the middle of the session communication as a matter of course.

### SUMMARY

The applicant of the present application has filed a patent application concerning an apparatus for setting transmission path that detects a trouble occurred with an opposing SIP server when a session communication has already initiated and that is capable of continuing the session communication between the initiating terminal (User Agent Client, hereinafter referred to as UAC) and the receiving terminal (User Agent Server, hereinafter referred to as UAS) even when a trouble has occurred with a server relaying the communication in the middle of the session communication (Japanese Patent Application No. 2006-286856).

The present invention is improved upon the apparatus according to the patent application. FIG. 9 is a diagram illustrating a problem to be solved. Over an IP telephone network shown in FIG. 9, a communication between UAC 300a and UAS 300b is performed via SIP server B (SIP server 200B), SIP server M (SIP server 200M), and SIP server Y (SIP server 200Y). It is noted that SIP header names are indicated by their abbreviations in such a manner that “RURI” for Request-URI, “RR” for Record-Route, “C” for Contact, and “R” for Route.

When the SIP server M goes down due to a trouble in the middle of the session communication between the UAC and the UAS over the network, a SIP message transmitted from the UAC or a SIP message transmitted from the UAS does not arrive at the UAS or the UAC, respectively.

By utilizing the apparatus for setting transmission path, the SIP server Y may understand a communication state with the SIP server M, and set as a destination of a request message (re-INVITE request in FIG. 9) the SIP server B which is next to the SIP server M in a relay sequence of SIP servers in accordance with information contained in header information of the request message when the SIP server Y has understood that the communication state with the SIP server M is abnormal. Thus the SIP message transmitted from the UAC or the UAS may arrive at the UAS or the UAC, respectively, by skipping the SIP server M.

When the SIP server M is recovered, the SIP server Y may understand that the communication state with the SIP server M is normal and set the SIP server M as the destination of the request message (re-INVITE request in FIG. 9) in accordance with the information (which is contained in the header information of the request message) of the relay sequence of the SIP servers.

However, even when a trouble occurs with a server relaying a communication in the middle of a session communication and the server is recovered in the middle of the session communication, the apparatus for setting transmission path has had the following problems depending on a degree of the recovery. That is, when the server is recovered while involving clearance of the session resource including data needed for the session communication, the recovered server holds no information on the session communication relayed before the occurrence of the trouble and when the server receives the request in the middle of the session communication whose session resource is cleared, the server determines that the received request is an abnormal request for non-existing session communication. Therefore, the server responses a semi-normal response to the server that has transmitted the request to the recovered server and the request cannot be transmitted to a server which is as the next destination of the recovered server.

Especially when the recovered server receives a BYE request (terminating request) as a request in the session communication whose session resource has been cleared, a normal disconnecting process cannot be carried out in servers after the recovered server and a SIP server charging the UAC continues to charge even though the session communication is actually disabled.

An extension to SIP (RFC 4028) stipulated by the IETF (Internet Engineering Task Force) defines specifications of Session Timers function for confirming the state of the session communication. When the UAC, UAS and SIP servers have this session timers function, they decide an arbitral lifetime (session timer) with the terminals (UAC or UAS) as communication partners in initiating a session communication (call setting), always count time by a timer, and transmit a re-INVITE request (session refresh request) to the terminals (UAC or UAS) as the communication partners when a half of the lifetime (refresh timer) elapses.

When a response to the transmitted request is returned, the UAC, UAS, and SIP servers understand that the communication can be performed at that point of time, reset the timer, and repeatedly transmit the re-INVITE request and confirm whether there is a response (refreshing operation). When no response is returned even after the lifetime on the other hand, they determine that the communication is disabled and terminate the session communication.

Therefore, when the recovered server (the SIP server M in FIG. 9) receives the re-INVITE request as a request in the session communication whose session resource has been cleared, the recovered server transmits a response code (e.g., “481 Call/Transaction Does Not Exist”) indicating that the session communication does not exist to the transmitter SIP server (the SIP server Y in FIG. 9), resulting the next destination server (the SIP server B in FIG. 9) of the recovered server fails to update the session timer and terminates the session communication in contrary to a will of the communicators.

When a trouble occurs with the opposing server in the middle of a session communication and the opposing server is recovered after terminating this session communication, no problem arises.

That is, a problem arises when a trouble occurs with the opposing server in the middle of a session communication and the opposing server is recovered in the middle of the session communication (referred to as “when a trouble is experienced in the middle of a specific session communication” hereinafter).

The present invention has been made to solve the above-mentioned problem and its object is to provide a SIP server that is capable of continuing a session communication between a UAC and a UAS even when a trouble occurs with an opposing server relaying the communication in the middle of the session communication and the server is recovered while involving clearance of a session resource in the middle of the session communication.

According to an aspect of the present invention, there is provided a communication server for transferring a message in a session communication, wherein the communication server is connected to servers via communication networks. The communication server includes: a communication controller which receives the message and transmits the message in accordance with first information which is contained in the message and includes destinations of the message, a call data manager which manages second information which indicates whether each of the servers needs to be skipped, a bypass controller which determines whether to skip a specific server among the servers on the basis of the second information which is managed by the call data manager, a header controller which removes from the first information which is contained in the message a specified destination, and a call controller which instructs the header controller to remove a destination which indicates the specific server from the first information which is contained in the message when the call controller is instructed from the bypass controller.

When the call data manager is instructed, the call data manager may store the second information which indicates that a specified server needs to be skipped.

On the basis of a response message which is received from the specific server and contains third information which indicates that a specified session communication does not exist, the bypass controller may preferably determine that the specific server needs to be skipped and the bypass controller may preferably instruct the call data manager to store the second information which indicates that the specific server needs to be skipped.

The communication server may further include a bypass setter which receives an input signal and instructs, in accordance with the input signal, the call data manager to store the second information which indicates that the specific server needs to be skipped.

The communication server may preferably be a SIP server which complies with Session Initiation Protocol. The message may preferably be a SIP message which complies with Session Initiation Protocol. The first information may preferably include a transmission path which is contained in a Route header of the SIP message, wherein the transmission path indicates a sequence of devices through which the message is relayed.

### BRIEF DESCRIPTION OF THE DRAWINGS

FIG. 1 is a diagram for explaining a concept of a SIP server according to a first embodiment of the present invention;

FIG. 2 is a diagram for explaining setting of a transmission path of a message in SIP;

FIG. 3 is a functional block diagram illustrating a configuration of a SIP server according to the first embodiment of the present invention;

FIG. 4 is a sequence diagram illustrating a processing procedure of a SIP server according to the first embodiment of the present invention when the SIP server has detected recovery from a trouble;

FIG. 5 is a functional block diagram for explaining a bypass control procedure of a SIP server shown in FIG. 1;

FIG. 6 is a sequence diagram showing a processing procedure of the SIP server according to the first embodiment of the present invention when the SIP server has not detected a trouble and recovery from the trouble;

FIG. 7 is a functional block diagram illustrating a configuration of a SIP server according to a second embodiment of the present invention;

FIG. 8 is a sequence diagram illustrating a processing procedure of a SIP server according to the second embodiment of the present invention when an input device is used to set bypass requirement information; and

FIG. 9 is a diagram illustrating a problem to be solved.

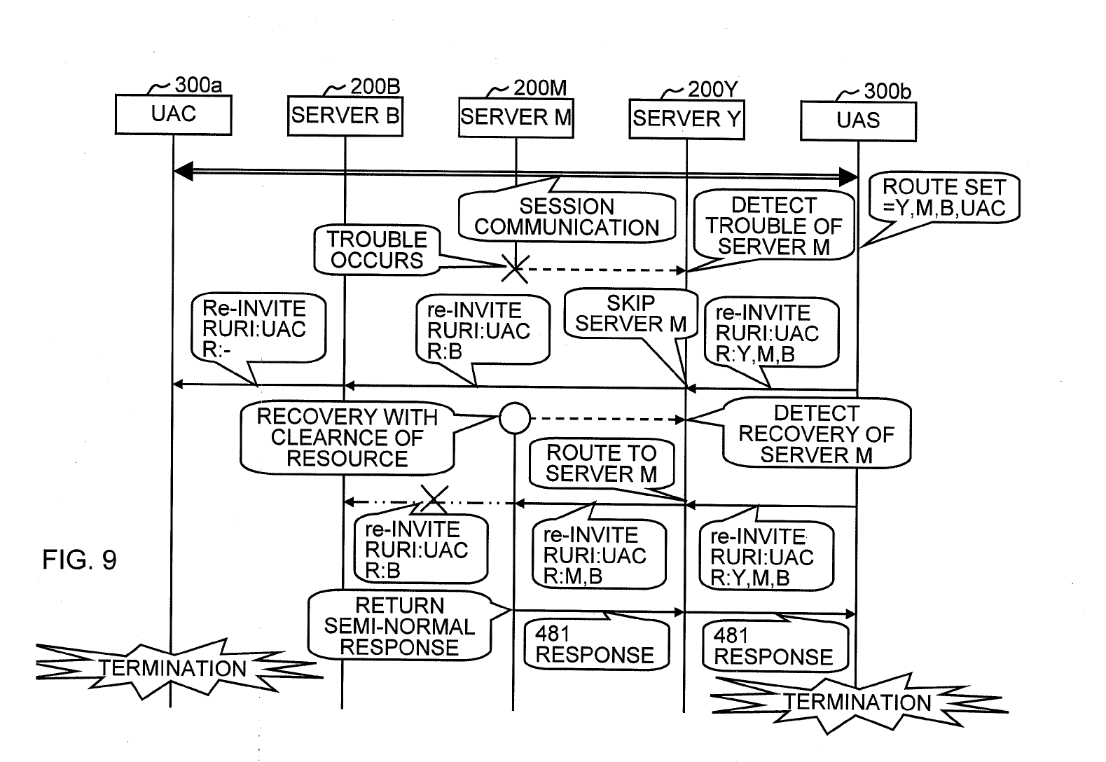

### DESCRIPTION OF THE PREFERRED EMBODIMENTS

### First Embodiment of the Invention

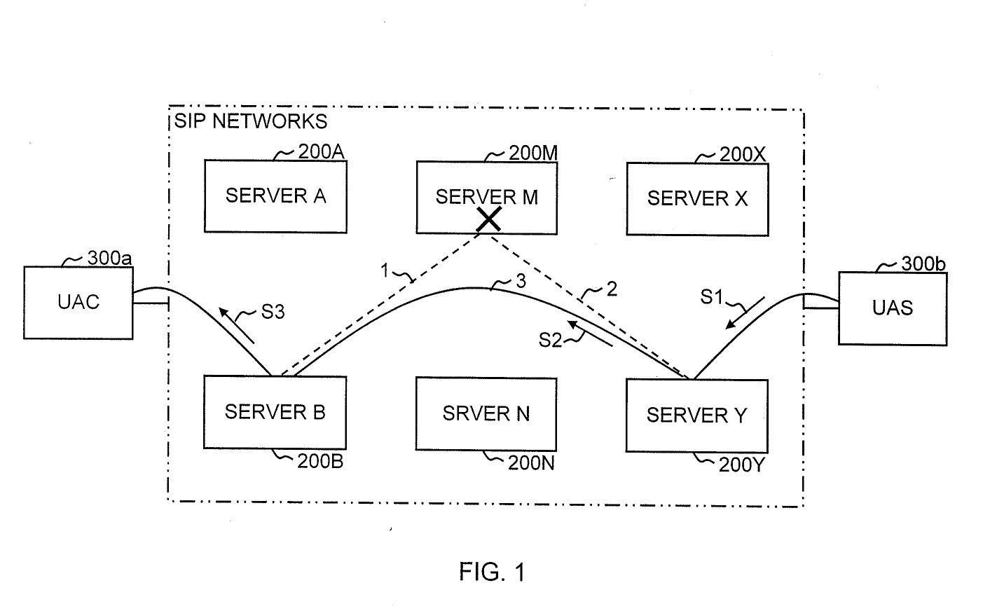

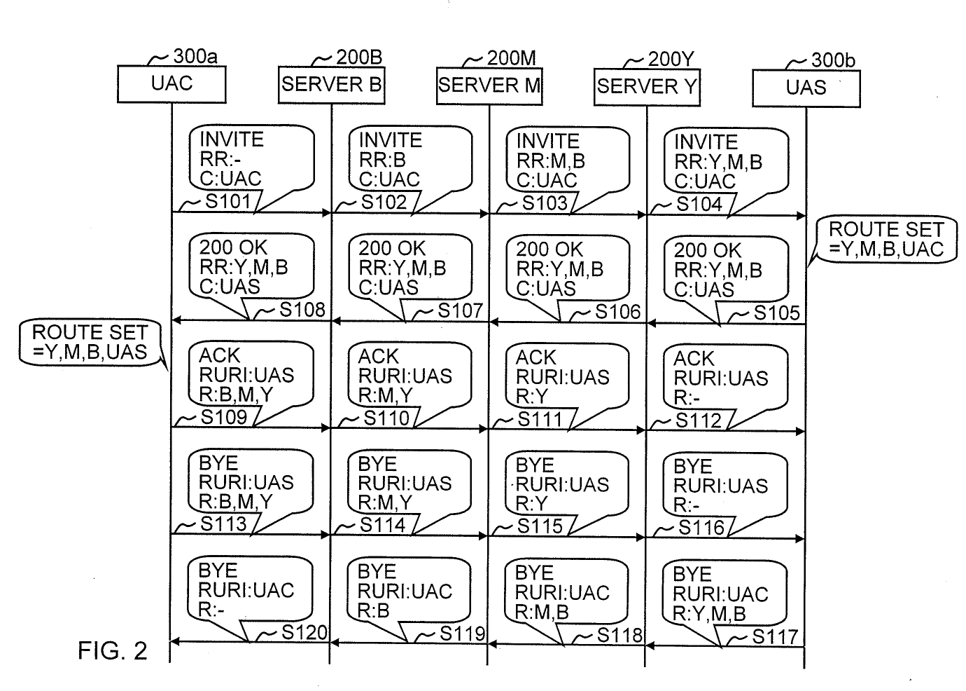

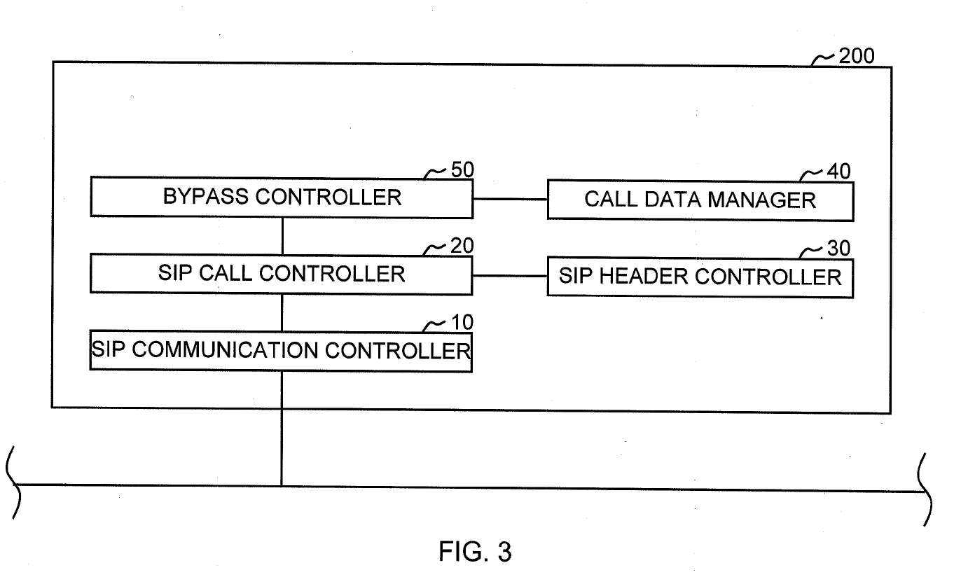

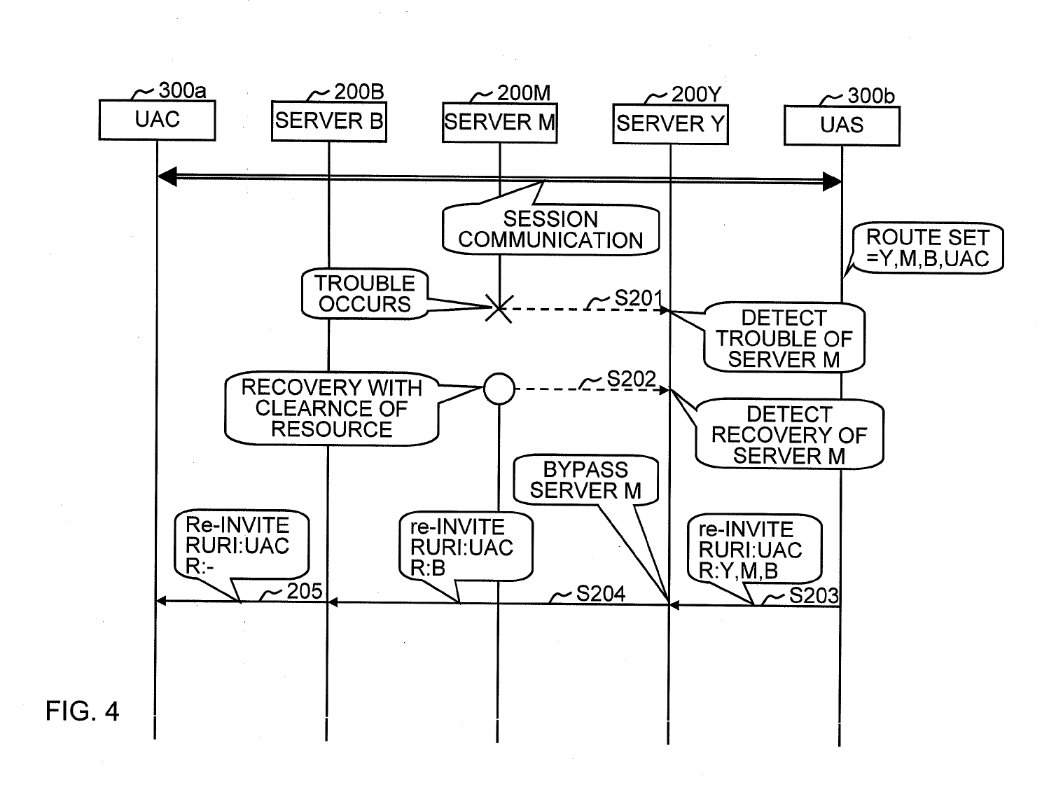

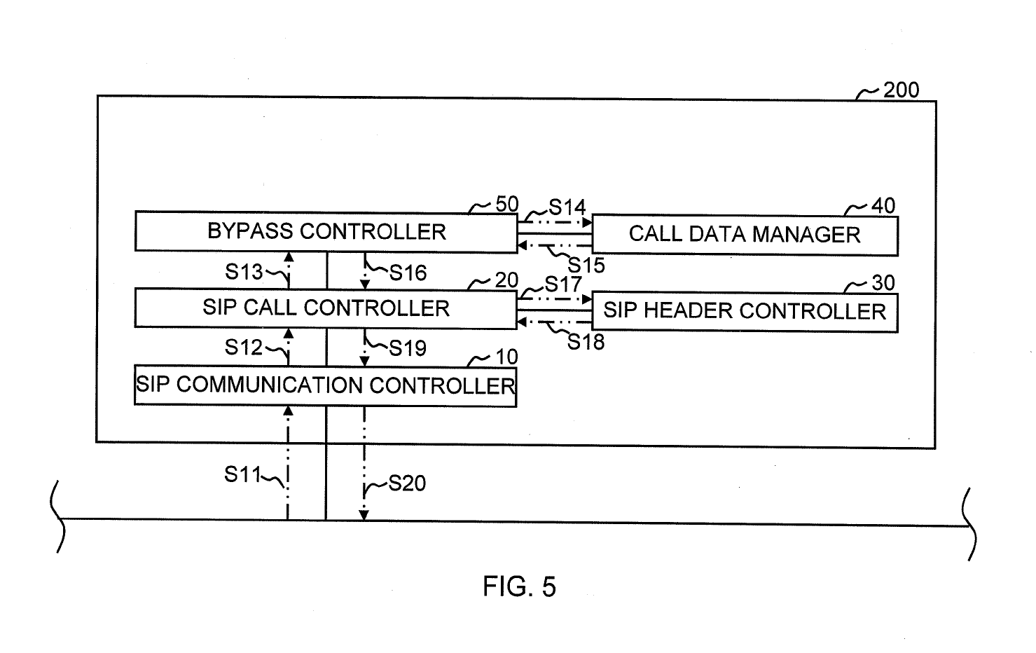

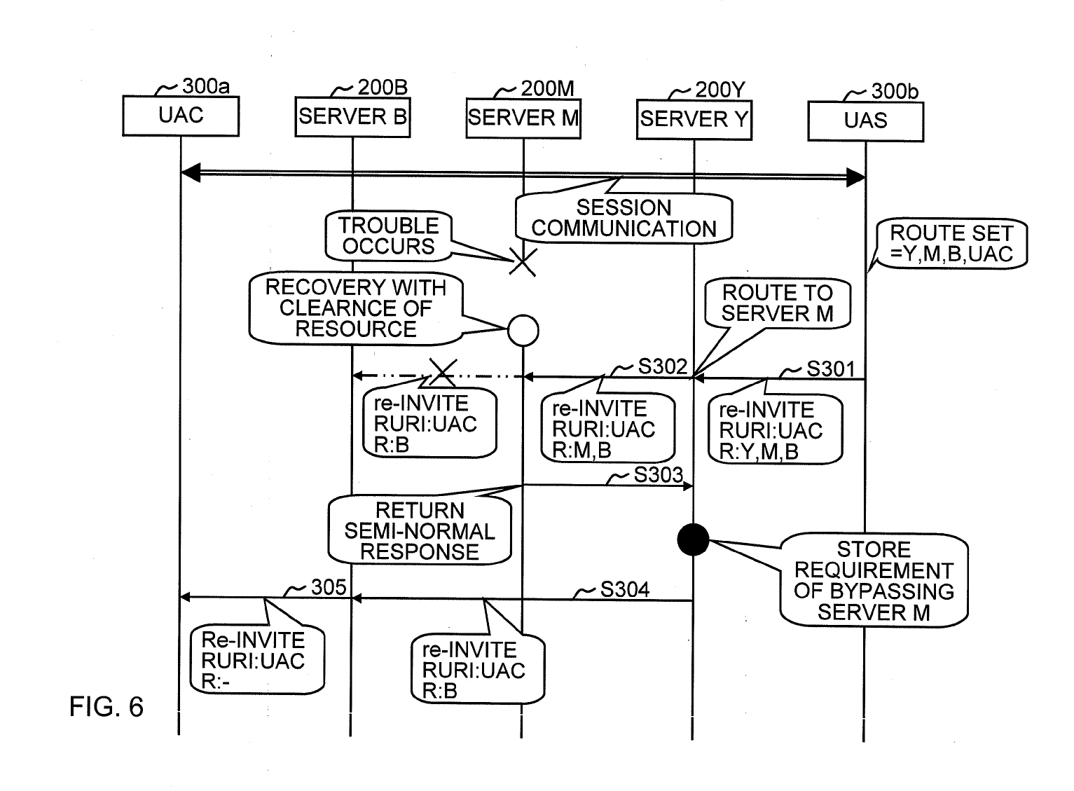

FIG. 1 is a diagram for explaining a concept of a SIP server according to a first embodiment of the present invention. FIG. 2 is a diagram for explaining setting of a transmission path of a message in SIP. FIG. 3 is a functional block diagram illustrating a configuration of a SIP server according to the first embodiment of the present invention. FIG. 4 is a sequence diagram illustrating a processing procedure of a SIP server according to the first embodiment of the present invention when the SIP server has detected recovery from a trouble. FIG. 5 is a functional block diagram for explaining a bypass control procedure of a SIP server shown in FIG. 1. FIG. 6 is a sequence diagram showing a processing procedure of the SIP server according to the first embodiment of the present invention when the SIP server has not detected a trouble and recovery from the trouble.

A concept of SIP servers 200 according to the first embodiment of the present invention will be described. FIG. 1 shows IP telephone networks of the first embodiment including SIP server A (SIP server 200A), SIP server B (SIP server 200B), SIP server M (SIP server 200M), SIP server N (SIP server 200N), SIP server X (SIP server 200X), and SIP server Y (SIP server 200Y). As shown in FIG. 1, the SIP server B is connected to the SIP server M via an IP network 1, the SIP server M is connected to the SIP server Y via an IP network 2 and the SIP server B is connected to the SIP server Y via an IP network 3, respectively.

In FIG. 1, UAC (initiating terminal 300a) represents a terminal (IP phone) of an initiator and UAS (receiving terminal 300b) represents a terminal (IP phone) of a receiver. As shown in FIG. 1, the UAC and the UAS perform a communication related to speech via the SIP server B, the SIP server M, and the SIP server Y.

In such IP telephone networks, each SIP server always confirms a communication state (whether a communication can be performed) with an opposing server and manages the result of the confirmation as communication state information. Furthermore, each SIP server always confirms a recovery state (whether the opposing server has been recovered with clearance of the session resource when a trouble is experienced in the middle of a specific session communication, that is, whether the session resource of the specific session communication exists in the opposing server) of the opposing server and determines for each session communication whether it is necessary to skip the opposing server on the basis of the result of the confirmation. Results of the determinations are managed as bypass requirement information. For example, the SIP server B manages the communication state with the SIP server M and the recovery state of the SIP server M as the communication state information and the bypass requirement information, respectively. Similarly, the SIP server M manages the communication state with the SIP server B and the recovery state of the SIP server B as well as the communication state with the SIP server Y and the recovery state of the SIP server Y, and the SIP server Y manages the communication state with the SIP server M and the recovery state of the SIP server M.

A SIP server determines necessity of skipping an opposing server for each session communication among session communications whose transmission path includes the opposing server as next destination. When a session resource of a session communication does not exist in the opposing server, the SIP server determines that it is necessary to skip the opposing server (the recovery state is abnormal) and skips the opposing server until the session communication terminates (call ending). When a session resource of a session communication exists in the opposing server, the SIP server determines that it is not necessary to skip the opposing server (the recovery state is normal).

Suppose that a certain session communication between the UAC and the UAS has already been initiated in SIP after exchanging messages such as INVITE request and then the UAS transmits BYE request to terminate the session communication (step S1 in FIG. 1). Suppose also that a transmission path of the BYE request is set in header information of the BYE request and the transmission path includes SIP server Y, SIP server M, and SIP server B in this order.

Upon receiving the BYE request, the SIP server Y refers to the header information of the BYE request to confirm that the next destination is the SIP server M and also confirms whether the SIP server Y can communicate with the SIP server M on the basis of the communication state information managed by the SIP server Y. The SIP server Y also confirms whether it is necessary to skip the SIP server M on the basis of the bypass requirement information managed by the SIP server Y when the SIP server M experiences a trouble in the middle of the specific session communication.

Suppose here that the communication with the SIP server M is interrupted due to a trouble or the like or that the communication with the SIP server M can be performed but the SIP server M has experienced a trouble in the middle of the specific session communication and no session resource of the specific session communication exists in the SIP server M. In such a case, the SIP server Y transmits the BYE request to the SIP server B that is set to be the next destination, skipping the SIP server M (step S2 in FIG. 1). At this time, the SIP server Y transmits the BYE request after removing information indicating the SIP server M from the transmission path which is set in the header information of the BYE request.

Upon receiving the BYE request, the SIP server B transmits the BYE request to the UAC that is requested to terminate the session communication by the BYE request (step S3 in FIG. 1).

As described above, the SIP server according to the first embodiment of the present invention determines the communication state with an opposing SIP server to which the request message is to be transmitted next. When the communication state with the opposing SIP server is determined to be abnormal, the SIP server according to the first embodiment sets as the destination of the request message the next SIP server to the opposing SIP server in a relay sequence of SIP servers on the basis of the information which is set in the header information of the request message.

When the communication state with the opposing SIP server is determined to be normal, the SIP server according to the first embodiment further determines the necessity of skipping the opposing SIP server. When it determines that it is necessary to skip the opposing SIP server, the SIP server according to the first embodiment sets as the destination of the request message the next SIP server to the opposing SIP server in a relay sequence of SIP servers on the basis of the information which is set in the header information of the request message.

FIG. 2 shows setting process of the transmission path performed by the SIP server B, SIP server M, and SIP server Y shown in FIG. 1. Before describing in detail the SIP server according to the first embodiment of the present invention, the setting process of the message transmission path performed by a SIP server will be described with reference to FIG. 2.

Upon each reception of a SIP message from UAC, UAS, or another SIP server, each SIP server identifies the next destination and transfers the SIP message. This identification of the destination is performed on the basis of a route set generated by the UAC or the UAS when the session communication is initiated. This route set is generated in accordance with a Record-Route header and a Contact header included in the header information of the INVITE request and a response message to the INVITE request.

The Record-Route header is a header in which the transmission path of the INVITE request is set or specifically, information indicating the SIP servers passed through in the transmission path of the INVITE request is set in order. The Contact header is a header in which information indicating a transmitter terminal that has transmitted the INVITE request or the response message.

For example, suppose that INVITE request to the UAS is transmitted from the UAC (step S101 in FIG. 2) and arrives at the UAS by being transferred in order of the SIP server B, the SIP server M, and the SIP server Y (steps S102 through S104 in FIG. 2). Then, information indicating the SIP server B, the SIP server M, and the SIP server Y which the INVITE request has transited is set in order in the Request-Route header of this INVITE request (“RR: Y, M, B” shown in FIG. 2) and information indicating the UAC that is the transmitter of the INVITE request is set in the Contact header (“C: UAC” shown in FIG. 2).

Upon receiving the INVITE request, the UAS generates a route set (“Y, M, B, UAC” shown in FIG. 2) in accordance with the Request-Route header and the Contact header of the INVITE request. Then, the UAS transmits to the UAC a 200 OK response (a response message in which a response code “200 OK” is set) indicating that the session initiating request by the INVITE request is accepted (step S105 in FIG. 2).

The 200 OK response transmitted from the UAS goes back the route through which the INVITE request has been transferred and arrives at the UAC by going through in the order of the SIP server Y, SIP server M, and SIP server B (steps S106 through S108 in FIG. 2). The same information with the Request-Route header of the INVITE request received by the UAS is set in the Request-Route header of this 200 OK response (“RR: Y, M, B” shown in FIG. 2) and information indicating the UAS who is the transmitter of the 200 OK response is set in the Contact header (“C: UAS” shown in FIG. 2).

Upon receiving the 200 OK response, the UAC generates a route set in accordance with the Request-Route header and the Contact header of the 200 OK response (“Y, M, B, UAS” shown in FIG. 2). Then, the UAC transmits to the UAS an ACK message indicating that the 200 OK response to the INVITE request has been accepted (step S109 in FIG. 2). The ACK message transmitted from the UAC is transferred in the order of the SIP server B, SIP server M, and SIP server Y by going through the same route with the INVITE request and arrives at the UAS (steps S110 through S112 in FIG. 2).

A session communication is initiated between the UAC and the UAS by going through the procedure described above (that is, in the middle of the session communication). After this, the transmission path is set in the header of the request message transmitted from the UAC or UAS in accordance with the route set generated in each terminal and each SIP server identifies the next destination of the request message in accordance with this transmission path.

For example, when the BYE request to terminate the session communication is transmitted from the UAC to the UAS (step S113 in FIG. 2) as shown in FIG. 2, Request URI header and Route header of the BYE request are set in accordance with the route set in the UAC (“RURI: UAS” and “R: B, M, Y” shown in FIG. 2).

The Request URI header is a header in which information indicating the destination (to which the request is sent) of the request message is set and the Route header is a header in which information indicating the transmission path in transmitting the request message is set (in order of transiting the SIP servers).

The BYE request transmitted from the UAC is transferred from the SIP server B to the SIP server M, from the SIP server M to the SIP server Y, and from the SIP server Y to the UAS in accordance with the information which is in the Request URI header and the Route header (steps S114 through S116 in FIG. 2).

When a BYE request is transmitted from the UAS to the UAC (step S117 in FIG. 2), the Request URI header and the Route header of the BYE request are set in accordance with the route set (“RURI: UAC” and “R: Y, M, B” shown in FIG. 2) in the same manner and the BYE request is transferred from the SIP server Y to the SIP server M, from the SIP server M to the SIP server B, and from the SIP server B to the UAC in accordance with the header information (steps S118 through S120 in FIG. 2).

Thus, after a session communication between the UAC and the UAS has been initiated in a network using SIP, a transmission path is set in the Route header of a request message transmitted from the UAC or the UAS in accordance with a route set generated in each terminal and each SIP server identifies the next destination of the request message in accordance with this transmission path.

FIG. 3 shows a configuration of a SIP server according to the first embodiment of the present invention. A configuration of a SIP server according to the first embodiment of the present invention will be described with reference to FIG. 3. The SIP server 200 is a software switch as a system for switching call processing typically including a function of controlling the call processing and a function of controlling communications. As shown in FIG. 3, the SIP server 200 includes a SIP communication controller 10, a SIP call controller 20, a SIP header controller 30, a call data manager 40, and a bypass controller 50. It is noted that components not directly related to the improved features are omitted in the configuration of the SIP server 200 shown in FIG. 3 and the SIP server 200 may include components having various functions such as a maintenance function.

The SIP communication controller 10 is a processing section for controlling transmission/reception of a SIP message complying with SIP. For example, the SIP communication controller 10 transmits to or receives from the opposing server a request message (such as the INVITE request, BYE request, and re-INVITE request) or a response message in which a response code (such as “200 OK” and “100 Trying”) is set.

The SIP call controller 20 is a processing section using SIP for controlling calls. As a function related to the first embodiment of the present invention, the SIP call controller 20 inquires to the bypass controller 50 in transmitting a request message whether to skip a SIP server designated to be the next destination. When the bypass controller 50 instructs to skip the SIP server, the SIP call controller 20 instructs the SIP header controller 30 to remove information indicating the next destination SIP server from the transmission path which is set in the header information of the request message and transmits the request message to a SIP server which is set as the next destination of the SIP server to be skipped.

When the bypass controller 50 instructs not to skip the next destination SIP server, the SIP call controller 20 transmits the request message to the SIP server designated to be the next destination in accordance to the transmission path which is set in the header information of the request message. When the destination SIP server operates normally (the communication state is normal and the recovery state is normal), a response message indicating that the request message has been normally accepted is returned. However, when some abnormality (the communication state is abnormal or the communication state is normal but the recovery state is abnormal) has occurred in the destination SIP server, a response message indicating that the request message has not been normally accepted is returned or a response message itself is not returned.

Then, when a response message to the transmitted request message, in which a response code indicating a state that the service is stopped (e.g., “503 Service Unavailable”) is set, is returned from the destination SIP server or no response message is returned from the destination SIP server even after an elapse of a predetermined time, the SIP call controller 20 determines that a communication with the next destination SIP server can not be performed. The SIP call controller 20 then instructs the SIP header controller 30 to remove information indicating the SIP server from the transmission path which is set in the header information of the request message and transmits the request message to a SIP server which is set as the next destination of the SIP server to be skipped.

When a response message to the transmitted request message, in which a response code indicating that the session communication does not exist (e.g., “481 Call/Transaction Does Not Exist”) is set, is returned from the destination SIP server, the SIP call controller 20 informs the bypass controller 50 that this response message has been returned. The bypass controller 50 understands that a communication with the destination SIP server can be performed but the destination SIP server has experienced a trouble in the middle of the session communication and no session resource of the session communication exists in the destination SIP server and determines that it is necessary to skip the destination SIP server until the session communication terminates. The bypass controller 50 instructs the call data manager 40 to store the result of the determination as bypass requirement information and instructs the SIP call controller 20 to skip the SIP server. The SIP call controller 20 then instructs the SIP header controller 30 to remove information indicating the SIP server from the transmission path which is set in the header information of the request message and transmits the request message to a SIP server which is set as the next destination of the SIP server to be skipped.

In the first embodiment, the SIP call controller 20 determines to skip the destination SIP server and transmits the request message to the next SIP server of the destination SIP server to be skipped when a communication with the destination SIP server can not be performed or no session resource of the session communication exists in the destination SIP server. The SIP call controller 20 may further confirm the communication state and recovery state of the next SIP server. When a communication with the next SIP server can not be performed or when no session resource of the session communication exists in the next SIP server, the SIP call controller 20 may transmit the request message to the still next SIP server.

Alternatively, the SIP call controller 20 may select any one SIP server among the SIP servers beyond the destination SIP server to be skipped and transmit the request message to the selected SIP server when the SIP call controller 20 has determined to skip the destination SIP server by reason that a communication with the destination SIP server can not be performed or no session resource of the session communication exists in the destination SIP server.

The SIP header controller 30 is a processing section for controlling headers of SIP messages in accordance with the instruction from the SIP call controller 20. The SIP header controller 30 performs editing (such as generating and deleting headers) in complying with SIP. As a function related to the first embodiment of the present invention, the SIP header controller 30 removes the information indicating the next destination SIP server from the transmission path which is set in the Route header of the request message in accordance with the instruction from the SIP call controller 20.

As described above, when a communication with a destination SIP server can not be performed or no session resource of the session communication exists in the destination SIP server, the SIP call controller 20 instructs the SIP header controller 30 to remove the information indicating the destination SIP server from the transmission path which is set in the Route header of the request message. Thus the request message can be transmitted by setting a bypass route which bypasses the destination SIP server with which a trouble is occurring or in which no session resource of the session communication exists.

The call data manager 40 is a processing section for managing the communication state information with the opposing server and the bypass requirement information of the opposing server for each session communication. The call data manager 40 always confirms whether a communication can be performed with the opposing server and whether a session resource of a specific session communication exists when the opposing server has experienced a trouble in the middle of the specific session communication and stores the communication state information and the bypass requirement information generated in accordance with the result of the confirmation in a memory (not shown) in FIG. 3 for example. When no session resource for a session communication exists in the opposing server, the call data manager 40 stores information indicating that the opposing server is to be skipped until the session communication terminates, as the bypass requirement information. When the call data manager 40 receives an inquiry for confirming the communication state information and bypass requirement information of the opposing server from the bypass controller 50 described later, the call data manager 40 confirms the communication state and the requirement of bypassing of the designated opposing server with reference to the communication state information and the bypass requirement information and notifies the result of the confirmation to the bypass controller 50.

The bypass controller 50 is a processing section for determining whether to skip a SIP server designated to be the next destination when the request message is transmitted. Specifically, the bypass controller 50 confirms in response to the inquiry from the SIP call controller 20 in routing a SIP signal whether a communication with the next destination SIP server of the request message can be performed by making an inquiry to the call data manager 40. When a communication cannot be performed with the SIP server, the bypass controller 50 instructs the SIP call controller 20 to skip the SIP server. When a communication with the next destination SIP server can be performed, the bypass controller 50 confirms in response to the inquiry from the SIP call controller 20 in routing a SIP signal whether the opposing server needs to be skipped by making an inquiry to the call data manager 40. When it is necessary to skip the SIP server, the bypass controller 50 instructs the SIP call controller 20 to skip the SIP server for the session communication and when it is not necessary to skip the SIP server, the bypass controller 50 instructs the SIP call controller 20 not to skip the SIP server for the session communication.

Next, a processing procedure of the SIP server according to the first embodiment of the present invention will be described. The following description will be made by exemplifying several assumed states upon a trouble with the SIP server M after initiating a session communication between the UAC and the UAS through the procedure shown in FIG. 2.

With reference to FIGS. 4 and 5, a case will be described where a trouble occurs with the SIP server M, the trouble is recovered while involving clearance of the session resource, and the SIP server Y detects the recovery. Suppose that the trouble occurs with the SIP server M in the middle of the session communication between the UAC and the UAS (step S201 in FIG. 4) as shown in FIG. 4 and then the trouble is recovered while involving clearance of the session resource and the SIP server Y detects the recovery involving clearance of the session resource (step S202 in FIG. 4).

Assume a case where the UAS transmits a re-INVITE request for example in this state as shown in FIG. 4. The UAS sets, in accordance with the route set, “RURI: UAC” and “R: Y, M, B” (the transmission path indicating that the request is transferred in the order of the SIP server Y, SIP server M, and SIP server B) in the Request URI header and the Route header, respectively, and then transmits the re-INVITE request to the SIP server Y in accordance with the transmission path which is set in the Route header (step S203 in FIG. 4).

In the SIP server Y, the SIP communication controller 10 receives the re-INVITE request (step S11 in FIG. 5) and the SIP call controller 20 obtains the next destination of the re-INVITE request on the basis of the Route header (step S12 in FIG. 5). Here, the SIP call controller 20 obtains the SIP server M as the next destination. Then, the SIP call controller 20 makes an inquiry to the bypass controller 50 whether the obtained destination (the SIP server M) should be skipped (step S13 in FIG. 5).

The bypass controller 50 makes an inquiry to the call data manager 40 whether a communication with the SIP server M can be performed and whether the SIP server M needs to be skipped (step S14 in FIG. 5). Because it is detected that the trouble with the SIP server M has been already recovered while involving clearance of the session resource, the call data manager 40 notifies that communication with the SIP server M can be performed but the SIP server M needs to be skipped (step S15 in FIG. 5). Upon receiving this notification, the bypass controller 50 instructs the SIP call controller 20 to skip the SIP server M (step S16 in FIG. 5).

Upon receiving the instruction from the bypass controller 50, the SIP call controller 20 instructs the SIP header controller 30 (step S17 in FIG. 5) to remove the information indicating the SIP server M from the transmission path which is set in the Route header of the re-INVITE request (step S18 in FIG. 5). Thereby, the SIP server B becomes the next destination of the re-INVITE request. Then, the SIP call controller 20 transmits the re-INVITE request with edited Route header to the SIP server B via the SIP communication controller 10 (step S19 and step S20 in FIG. 5, and step S204 in FIG. 4).

Then, the re-INVITE request transmitted from the SIP server Y is transferred to the SIP server B and from the SIP server B to the UAC in accordance with the transmission path which is set in the Route header (step S205 in FIG. 4).

Thus, in the case where the trouble that has occurred with the SIP server M is recovered while involving clearance of the session resource and when the SIP server Y has detected the recovery, the bypass controller 50 in the SIP server Y confirms that a communication with the SIP server M can be performed but the SIP server M needs to be skipped by making an inquiry to the call data manager 40 and the SIP call controller 20 skips the SIP server M and transmits the re-INVITE request to the next destination SIP server B, so that the session communication between the UAC and the UAS may be continued.

With reference to FIGS. 5 and 6, a case will be described where a trouble occurs with the SIP server M and the trouble is recovered, but the SIP server Y does not detect the trouble and the recovery. Suppose that the trouble occurs with the SIP server M and is recovered but the SIP server Y does not detect the trouble and the recovery as shown in FIG. 6.

Assume a case where the UAS transmits a re-INVITE request for example in this state as shown in FIG. 6. The UAS sets, in accordance with the route set, “RURI: UAC” and “R: Y, M, B” (the transmission path indicating that the request is transferred in the order of the SIP server Y, SIP server M, and SIP server B) in the Request URI header and the Route header, respectively, and then transmits the re-INVITE request to the SIP server Y in accordance with the transmission path which is set in the Route header (step S301 in FIG. 6).

In the SIP server Y, the SIP communication controller 10 receives the re-INVITE request (step S11 in FIG. 5) and the SIP call controller 20 obtains the next destination of the re-INVITE request on the basis of the Route header (step S12 in FIG. 5). Here, the SIP call controller 20 obtains the SIP server M as the next destination. Then, the SIP call controller 20 makes an inquiry to the bypass controller 50 whether the obtained destination (the SIP server M) should be skipped (step S13 in FIG. 5).

The bypass controller 50 makes an inquiry to the call data manager 40 whether a communication with the SIP server M can be performed and whether the SIP server M needs to be skipped (step S14 in FIG. 5). Because the trouble and recovery of the SIP server M is not detected here, the call data manager 40 notifies that a communication with the SIP server M can be performed and it is unnecessary to skip the SIP server M (step S15 in FIG. 5). Upon receiving this notification, the bypass controller 50 instructs the SIP call controller 20 not to skip the SIP server M (step S16 in FIG. 5).

Upon receiving the instruction from the bypass controller 50, the SIP call controller 20 transmits the re-INVITE request without changing the transmission path which is set in the Route header. Thereby, the next destination of the re-INVITE request is the same when it is received and is the SIP server M. Then, the SIP call controller 20 transmits the re-INVITE request to the SIP server M via the SIP communication controller 10 (step S19 and step S20 in FIG. 5, and step S302 in FIG. 6).

Here, suppose a case where the trouble that has stopped the service of the SIP server M is recovered while involving clearance of the session resource and therefore a response message containing a response code indicating that no session communication exists (e.g., “481 Call/Transaction Does not Exist”) is set is returned from the SIP server M to the SIP server Y (step S303 in FIG. 6).

In this case, the SIP communication controller 10 in the SIP server Y receives the response message (step S11 in FIG. 5) and transmits the response message to the bypass controller 50 via the SIP call controller 20 (step S12 and step S13 in FIG. 5).

On the basis of the response message, the bypass controller 50 understands that a communication with the SIP server M can be performed but the session resource of the session communication does not exist in the SIP server M and that the SIP server M needs to be skipped until the session communication terminates. The bypass controller 50 instructs the call data manager 40 to store the result of the determination as the bypass requirement information (step S14 in FIG. 5) and instructs the SIP call controller 20 to skip the SIP server M (step S16 in FIG. 5).

The SIP call controller 20 instructs the SIP header controller 30 (step S17 in FIG. 5) to remove the information indicating the SIP server M from the transmission path which is set in the Route header of the re-INVITE request (step S18 in FIG. 5). Thereby, the SIP server B becomes the next destination of the re-INVITE request. Then, the SIP call controller 20 transmits the re-INVITE request with edited Route header to the SIP server B via the SIP communication controller 10 (step S19 and step S20 in FIG. 5, and step S304 in FIG. 6).

Then, the re-INVITE request transmitted from the SIP server Y is transferred to the SIP server B and from the SIP server B to the UAC in accordance with the transmission path which is set in the Route header (step S305 in FIG. 6).

Thus, in the case where the SIP server Y does not detect the trouble that has occurred with the SIP server M and the recovery thereof, the SIP call controller 20 in the SIP server Y determines whether a communication with the SIP server M can be performed and whether the SIP server M needs to be skipped by transmitting a re-INVITE request to the SIP server M, confirming a response code contained in a response message to the re-INVITE request. When the SIP call controller 20 determines that a communication with the SIP server M can be performed but the SIP server M needs to be skipped, the SIP call controller 20 skips the SIP server M and transmits the re-INVITE request to the next destination SIP server B, so that the session communication between the UAC and the UAS may be continued.

As described above, in the first embodiment, the bypass controller 50 makes an inquiry to the call data manager 40 to determine the communication state with the SIP server to which the request message is to be transmitted next and the recovery state thereof When the bypass controller 50 determines that the communication state with the SIP server to which the request message is to be transmitted next or the recovery state thereof is abnormal, the SIP call controller 20 sets as the destination of the SIP message the next SIP server to the abnormal SIP server in a relay sequence of SIP servers on the basis of the information which is set in the header information of the request message. Therefore, when a trouble occurs with the SIP server that relays the communication in the middle of the session communication and even if the server is recovered while involving clearance of a session resource of the opposing server in the middle of the session communication, it becomes possible to transmit the SIP message by skipping the SIP server and the session communication between the UAC and the UAS may be continued.

Still more, in the first embodiment, the SIP call controller 20 transmits the SIP message to the next destination SIP server and determines communication state with the next destination SIP server and recovery state thereof on the basis of a response message returned to the transmitted SIP message, so that it becomes possible to determine whether to skip the next destination SIP server by discriminating the communication state under more detailed conditions in on the basis of contents of the communication state and recovery state.

Furthermore, in the first embodiment, the SIP call controller 20 determines the communication state and recovery state on the basis of the response code (indicating the state of the SIP server) contained in the response message, so that it becomes possible to transmit the SIP message by skipping a SIP server even if the SIP server temporarily stops its service due to congestion or the like and to continue the session communication between the UAC and the UAS.

Still more, when the bypass controller 50 determines that the communication state with the next destination SIP server or the recovery state thereof is abnormal, the SIP call controller 20 instructs the SIP header controller 30 to remove the information concerning the next destination SIP server which is set in the Route header contained in the SIP message and sets the destination of the SIP message, so that it becomes possible to transmit the SIP message without changing the data structure of the header information defined in SIP by skipping the opposing server with which a trouble is occurring and to continue the session communication between the UAC and the UAS.

It is noted that although the above-mentioned description has been made by exemplifying the re-INVITE request, the invention is not limited by this and other request messages (such as the BYE request) transmitted after initiating the session communication may be applied in the same manner.

### Second Embodiment of the Invention

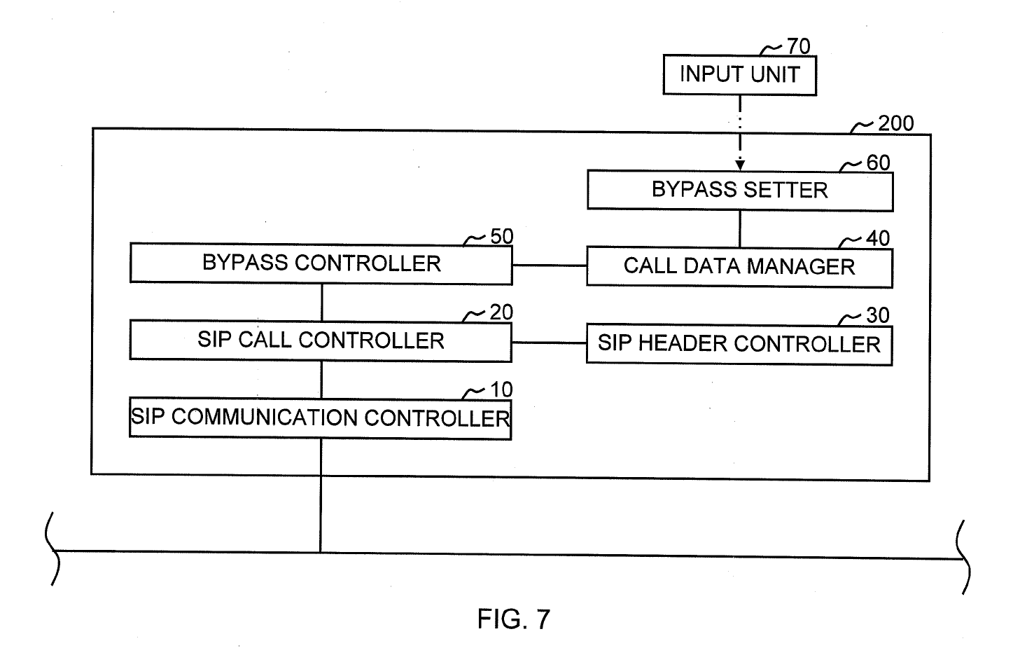

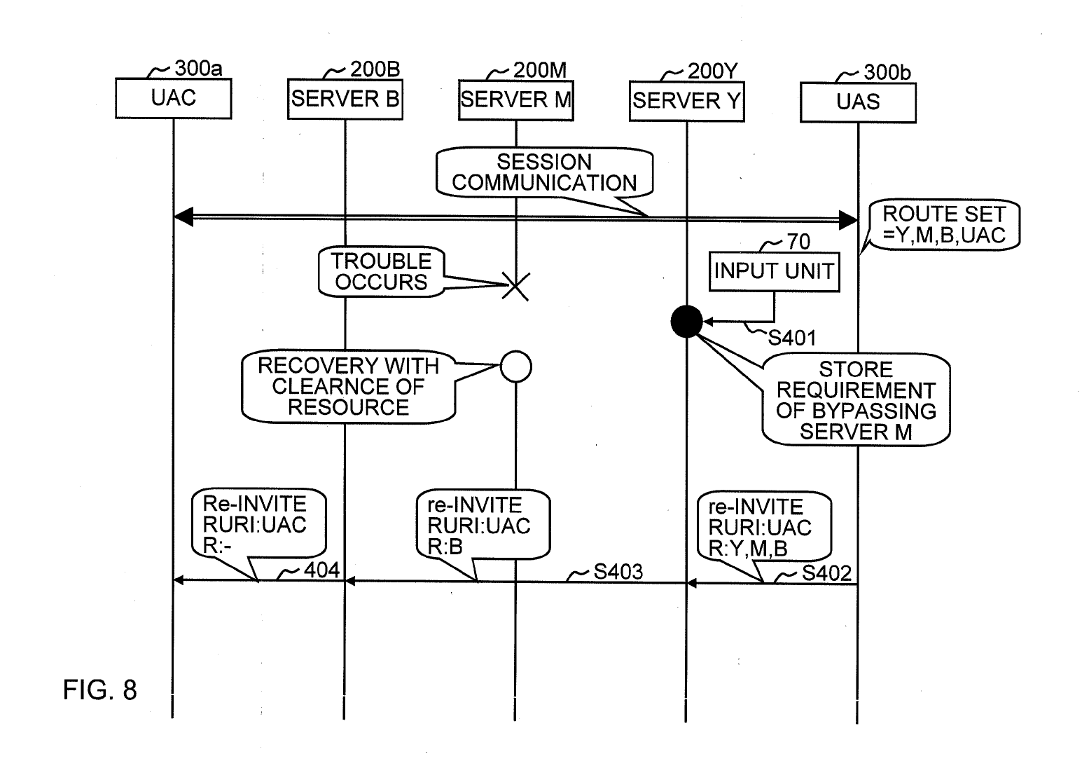

FIG. 7 is a functional block diagram illustrating a configuration of a SIP server according to a second embodiment of the present invention. FIG. 8 is a sequence diagram illustrating a processing procedure of a SIP server according to the second embodiment of the present invention when an input device is used to set bypass requirement information. Like reference numerals refer to like parts in throughout the drawings and a description thereof will be omitted here.

A bypass setter 60 has an input interface (not shown) that receives an input signal such as a command from the outside through an input device 70 such as a keyboard and a mouse and instructs the call data manager 40 to store the bypass requirement information based on the input signal from the input device 70.

It is noted that the SIP server according to the second embodiment is different from the SIP server according to the first embodiment in that the SIP server according to the second embodiment further includes the bypass setter 60 and the SIP server according to the second embodiment brings about the same action and effect with the SIP server according to the first embodiment except for those of the bypass setter 60 described below.

Suppose that an established session communication exists between the UAC and the UAS in the second embodiment. When a trouble occurs with a server relaying the communication in the middle of the session communication and a third party such as a maintenance personnel carries out the recovery of the server involving clearance of the session resource in the middle of the session communication, the third party inputs, to the SIP server Y that is the transmitter to the SIP server M that caused the trouble, from the outside by using the input device 70 a bypass command for skipping the SIP server M until the session communication between the UAC and the UAS at this point of time terminates (step S401 in FIG. 8).

The bypass setter 60 instructs the call data manager 40 to store the bypass requirement information based on the input signal as a bypass command from the outside and the call data manager 40 stores so as to bypass the SIP server M until the session communication terminates (call ending).

Then, when the SIP server M is recovered while involving clearance of the session resource, the second embodiment enables the SIP server to skip the SIP server M until the session communication terminates on the basis of the bypass requirement information managed by the call data manager 40 in the same manner with steps S203 through S205 shown in FIG. 4 in the first embodiment described above (steps S402 through S404 in FIG. 8).

It is noted that it is possible to eliminate the process of determining that the SIP server M needs to be skipped on the basis of the response message from the destination SIP server M to the request message transmitted from the transmitter SIP server Y (i.e., steps S302 and S303 shown in FIG. 6 in the first embodiment described above) by asking the call data manager 40 to store the bypass requirement information based on the input signal from the input device 70 in advance before transmitting the request message in the session communication from the initiating SIP server Y to the SIP server M.

Since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A communication server for transferring a message in a session communication, said communication server being connected to servers via communication networks, said communication server comprising:
a communication controller for
receiving the message, and
transmitting the message in accordance with first information contained in the message, said first information including destinations of the message;
a call data manager for managing second information indicating whether each of the servers needs to be skipped;
a bypass controller for determining whether to skip a specific server among the servers on the basis of the second information managed by the call data manager;
a header controller for removing from the first information contained in the message a specified destination; and
a call controller for instructing the header controller, upon being instructed from the bypass controller, to remove a destination indicating the specific server from the first information contained in the message.

2. The communication server of claim 1, wherein
the call data manager stores, upon being instructed, the second information indicating that a specified server needs to be skipped.

3. The communication server of claim 1, wherein
on the basis of a response message received from the specific server, said response message containing third information indicating that a specified session communication does not exist, the bypass controller determines that the specific server needs to be skipped and instructs the call data manager to store the second information indicating that the specific server needs to be skipped.

4. The communication server of claim 1, further comprising:
a bypass setter for
receiving an input signal, and
instructing, in accordance with the input signal, the call data manager to store the second information indicating that the specific server needs to be skipped.

5. The communication server of claim 1, wherein
the communication server is a SIP server complying with Session Initiation Protocol,
the message is a SIP message complying with Session Initiation Protocol, and
the first information includes a transmission path contained in a Route header of the SIP message, said transmission path indicating a sequence of devices through which the message is relayed.
